(19) United States
(12) Patent Application Publication
(10) Pub. No.: US 2026/0326121 A1
(43) Pub. Date: Oct. 22, 2026

(54) SHOWERHEAD WITH VAPOR DISPENSING SYSTEM

(71) Applicant: KOHLER CO., Kohler, WI (US)

(72) Inventors: Andrea Eloisa CARDENAS RAMOS, San Nicolas de los Garza (MX); Thomas DOS SANTOS OLIVEIRA, Guadalupe (MX); Evan See-Leet YEE, Port Washington, WI (US); Ryan Frederick LEICHTY, Kohler, WI (US)

(73) Assignee: KOHLER CO., Kohler, WI (US)

(21) Appl. No.: 19/642,348

(22) Filed: Apr. 8, 2026

Related U.S. Application Data
(60) Provisional application No. 63/792,618, filed on Apr. 22, 2025.

(51) Int. Cl. B05B 1/18; E03C 1/04

(52) U.S. Cl. CPC B05B 1/1821; B05B 1/192; E03C 1/0408

(57) ABSTRACT

A showerhead for generating a fog of water includes a flow device, a flow distribution member, and a water vapor dispensing system. The flow distribution member is coupled to the flow device and is spaced apart from the flow device by a region that is open to an atmosphere surrounding the showerhead. The water vapor dispensing system is coupled to the flow distribution member. The water vapor dispensing system includes a mist element that is configured to generate a mist within the region from fluid received by the flow distribution member.

### CROSS-REFERENCE TO RELATED APPLICATIONS

This application claims the benefit of, and priority to, U.S. Provisional Application No. 63/792,618, filed Apr. 22, 2025, the entire contents of which are incorporated by reference herein.

### BACKGROUND

The present application relates generally to the field of showers and showerheads.

Showerheads are generally configured to dispense water to a user-occupied space within a shower. A showerhead can be connected to a water source via a household water supply line extending from a side wall or an upper wall of a fixed structure, such as a building or a shower enclosure. The showerhead can produce a spray of water to facilitate cleaning operations and/or to enhance user comfort.

### SUMMARY

One embodiment relates to a showerhead including a flow device, a flow distribution member, and a water vapor dispensing system. The flow distribution member is coupled to the flow device and is spaced apart from the flow device by a region that is open to an atmosphere surrounding the showerhead. The water vapor dispensing system is coupled to the flow distribution member. The water vapor dispensing system includes a mist element that is configured to generate a mist within the region from water received by the flow distribution member.

In some embodiments, the flow distribution member defines a cavity configured to receive and retain a volume of water during operation. In such embodiments, the showerhead further includes a support member coupling the flow device to the flow distribution member, and the mist element is supported in fluid receiving arrangement with the cavity by the support member.

In some embodiments, the flow distribution member includes: a distribution plate; and a lip extending along an outer perimeter of the distribution plate, where the distribution plate and the lip together defining a cavity facing toward the flow device. In some such embodiments, the water vapor dispensing system further includes a support frame disposed within the cavity and extending across at least a portion of the cavity, and the mist element coupled to the support frame.

In some embodiments, the water vapor dispensing system further includes a mist element cover coupled to the mist element and configured to direct mist received from the mist element away from the flow distribution member and at least partially toward the flow device.

In some embodiments, the water vapor dispensing system further includes a light element coupled to the flow distribution member, where the light element is configured to illuminate at least a portion of the region.

In some embodiments, the water vapor dispensing system further includes a controller configured to coordinate operation of the mist element with the light element.

In some embodiments, the flow distribution member defines a cavity configured to receive and retain a volume of water from the flow device during operation, and the mist element is disposed within the cavity.

In some embodiments, the mist element includes a piezoelectric device configured to generate an aerosolized mist of water.

In some embodiments, the water vapor dispensing system includes a support frame coupled to the flow distribution member and supporting the mist element, and the support frame defining an opening at the mist element configured to allow water to pass therethrough and onto the mist element.

Another embodiment relates to a water vapor dispensing system for a showerhead. The water vapor dispensing system includes: a mist element; a support frame configured to couple the mist element to the showerhead and configured to provide water delivered from the showerhead to the mist element; and a control system configured to control operation of the mist element.

In some embodiments, the support frame includes a mount defining a recessed area. In some such embodiments, the support frame defines an aperture that extends through a central portion of the recessed area, and the recessed area and the aperture together define a ledge. In some such embodiments, the mist element is disposed on the ledge.

In some embodiments, the support frame includes a support ring and an extension extending radially inwardly from the support ring, where the extension defining a mount, and the mist element is coupled to the mount.

In some embodiments, the mist element is one of a plurality of mist elements coupled to the support frame.

In some embodiments, the mist element is a piezoelectric device configured to generate an aerosolized mist of water, and the support frame is configured to support the mist element within a cavity of the showerhead.

In some embodiments, the water vapor dispensing system further includes a cover coupled to the support frame and extending over the mist element.

In some embodiments, an inner diameter of the cover decreases along an axial direction moving away from the mist element.

In some embodiments, the water vapor dispensing system further includes a light element coupled to the support frame, and the control system is configured to coordinate operation of the mist element with the light element.

Another embodiment relates to a water vapor dispensing system including: a mist element configured to be coupled to a showerhead and to generate an aerosolized mist from water delivered by the showerhead; a light element; a user interface; and a controller operably coupled to the user interface, the mist element, and the light element, where the controller is configured to: receive a fog characteristic from the user interface; and coordinate operation of the mist element and the light element based on the fog characteristic.

In some embodiments, the water vapor dispensing system further includes a support frame configured to couple the mist element and the light element to the showerhead.

In some embodiments, the controller is further configured to control at least one of a duty cycle or a frequency of operation of the mist element or the light element based on the fog characteristic.

### BRIEF DESCRIPTION OF THE FIGURES

FIG. 1 is a perspective view of a showerhead including a water vapor dispensing system, shown during one mode of operation of the water vapor dispensing system, according to an embodiment.

FIG. 2 is a perspective view of a showerhead of FIG. 1, according to an embodiment.

FIG. 3 is a top perspective view of the showerhead of FIG. 1.

FIG. 4 is an exploded perspective view of the showerhead of FIG. 1, according to an embodiment.

FIG. 5 is a block diagram of a control system for a water vapor dispensing and lighting system that can be used with the showerhead of FIG. 1, according to an embodiment.

### DETAILED DESCRIPTION

Referring generally to the Figures, disclosed herein are various embodiments of a showerhead (e.g., water delivery device, flow distribution assembly, etc.) that is configured to generate a lighted mist of aerosolized water vapor in an open region above the showerhead, on an opposite side of the showerhead from which a spray of water is discharged from the showerhead. In some embodiments, the showerhead is an open or partially open showerhead in which water passes between different components of the showerhead through a region that is open or partially open to an atmosphere surrounding the showerhead (e.g., such that air or water can pass into or out of the showerhead in areas other than a spray face).

In at least one embodiment, the showerhead includes a flow device, a flow distribution member, a support member, and a water vapor dispensing system. The flow distribution member is spaced apart from the flow device by the support member. The flow distribution member is configured to receive water from the flow device and distribute water across and through a spray face of the flow distribution member and into a shower enclosure. In some embodiments, a region between the flow device and the flow distribution member is open to the atmosphere surrounding the showerhead, such that a user can view at least a portion of the water flowing between the flow device and the flow distribution member without disassembling the showerhead. In some embodiments, the flow distribution member defines a cavity that is configured to receive and retain a volume of water from the flow device during operation.

In some embodiments, the showerhead also includes a support member that supports the water vapor dispensing system at least partially within the cavity defined by the flow distribution member. The water vapor dispensing system includes at least one mist element that is configured to generate a mist from water pooling within the cavity. In some embodiments, the water vapor dispensing system includes at least one nozzle configured to direct the mist into the shower enclosure through the region between the flow device and the flow distribution member. In some embodiments, the water vapor dispensing system also includes at least one light element that is configured to illuminate the mist in the open region during operation. Such an arrangement can create a calming, spa-like, experience with a soothing (e.g., visually appealing) aesthetic that can enhance a user’s overall showering experience.

In some embodiments, the water vapor dispensing system also includes a control system that is configured to control the misting and/or light effect generated by the water vapor dispensing system, which can allow for user personalization of the water mist and/or lighting effects.

In some embodiments, the water vapor dispensing system includes a support frame that is removable from the showerhead, which can facilitate replacement/service of one or more components of the water vapor dispensing system during maintenance events, and enable use and/or retrofit of different water vapor dispenser arrangements in a single showerhead aesthetic (e.g., without modifying other aspects of the showerhead design). These and other advantageous features will become apparent to those reviewing the present disclosure and Figures.

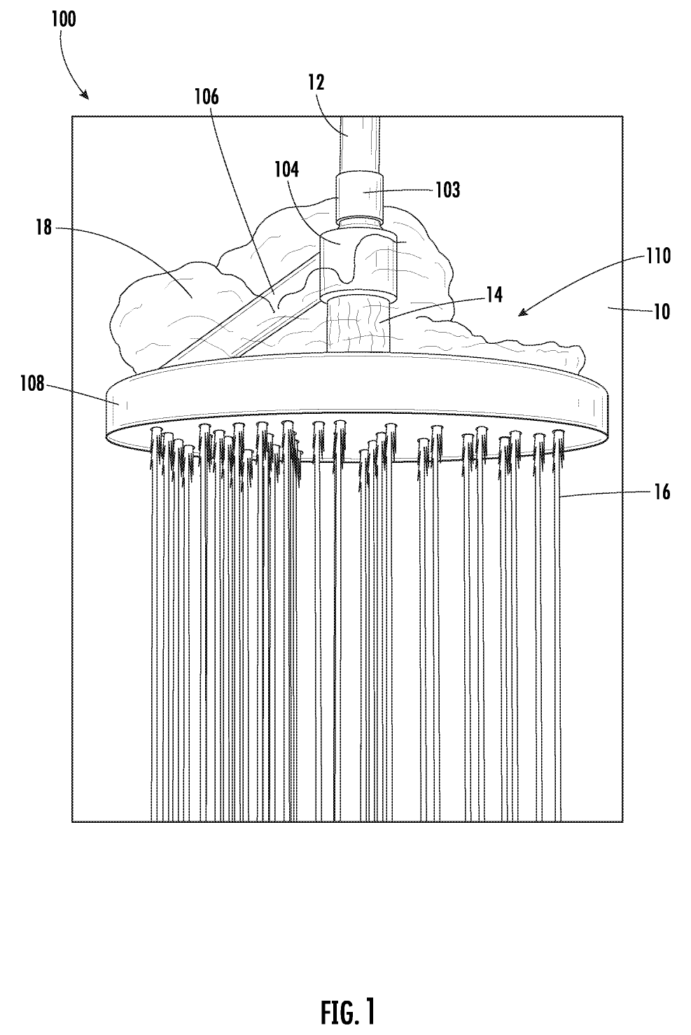

Referring to FIGS. 1–3, a showerhead 100 (which may also be referred to as a showerhead assembly and/or a spray head assembly) is shown, according to an embodiment. As used herein, “showerhead” refers generally to a water distribution device that may be used to provide water to a user within a shower or bath enclosure. In some embodiments, the showerhead is, or includes, a rainhead (e.g., a rain shower head) that is configured to distribute water from a supply line in the form of rain-like droplets of water. In such embodiments, the rainhead may be configured to simulate the experience of standing in a gentle rain. In other embodiments, the showerhead is, or includes, a cascade style showerhead that is configured to provide water in the form of a curtain of water, and/or another flow pattern that simulates the flow of a waterfall. In other embodiments, the showerhead may be another type of showerhead.

The showerhead 100 includes a showerhead connector 103 fluidly coupled to a water source within a shower enclosure 10. In particular, the showerhead connector 103 is removably coupled to a water supply conduit 12 that extends to the shower enclosure 10. In some embodiments, the water supply conduit 12 is configured as a water pipe extending from an upper wall of the shower enclosure 10. In some embodiments, the water supply conduit 12 is a pipe, tube, or other water delivery mechanism extending from a side wall of the shower enclosure 10. In the embodiment of FIG. 1, the water supply conduit 10 is a pipe disposed centrally within the upper wall of the shower enclosure 10 that extends vertically away from the upper wall.

The showerhead 100 includes a flow device 104, a support member 106, and a flow distribution member 108. In some embodiments, the showerhead 100, including the flow device 104, the support member 106, and the flow distribution member 108, is designed and arranged the same as, or similar to, any one of the showerheads described in U.S. Patent Application Number 16/547,265, filed Aug. 21, 2019, the entire contents of which are hereby incorporated by reference herein.

In some embodiments, and as shown in FIGS. 1–3, the flow device 104 is pivotably coupled to the showerhead connector 103 such that the flow device 104 can pivot at a connection point between the flow device 104 and the showerhead connector 103. In the embodiment of FIGS. 1–3, the flow device 104 extends vertically downward from the showerhead connector 103.

The flow distribution member 108 is coupled to the flow device 104. The flow distribution member 108 is spaced apart from the flow device by a region 110 that is open to an atmosphere surrounding the showerhead 100, such that a user may view a stream of water produced by the flow device 104 and passing between the flow device 104 and the flow distribution member 108.

Referring to FIG. 1, the flow device 104 is configured to produce a stream of fluid (e.g., a single stream of liquid water), shown as fluid stream 14. In some embodiments, the flow device 104 is configured to produce a single, substantially laminar, fluid stream. In the embodiment of FIG. 1, the flow device 104 is configured to produce fluid stream 14 over a first coverage area. The flow distribution member 108 is configured to receive the fluid stream 14 from the flow device 104 and to produce a distributed fluid flow 16 (e.g., a spray) over a second coverage area that is larger than the first coverage area. In some embodiments, the fluid stream 14, extending between the flow device 104 and the flow distribution member 108, is at least partially visible to a user or occupant of the shower.

The support member 106 is configured to couple the flow distribution member 108 to the flow device 104. The support member 106 is disposed between the flow device 104 and the flow distribution member 108 and is configured to carry the full weight of the flow distribution member 108. In some embodiments, the mist element 126 is supported in fluid receiving arrangement with a cavity of the flow distribution member 108 by the support member 106.

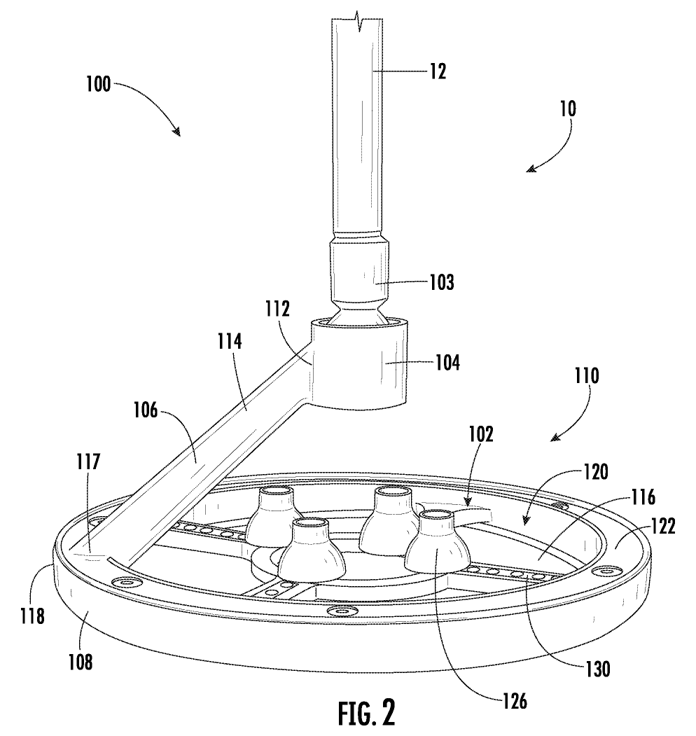

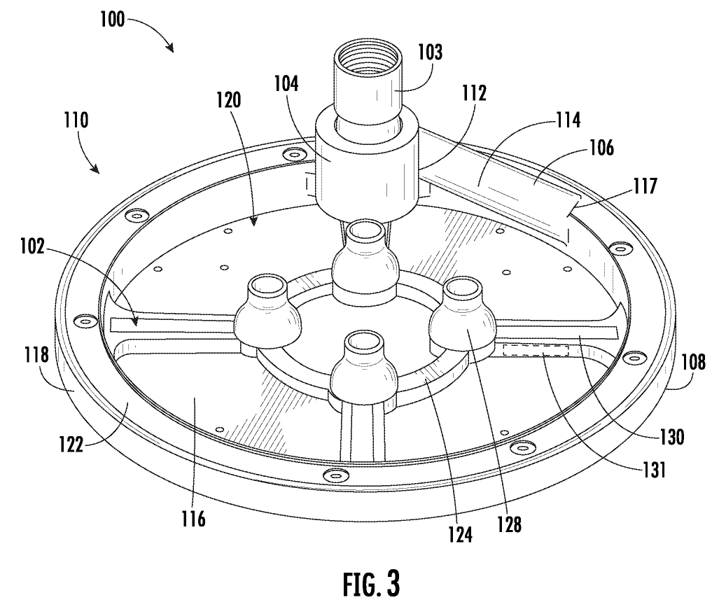

As shown in FIGS. 2–3, a first end 112 of the support member 106 is coupled to the flow device 104 via an extension piece (which may also be referred to as an angled body element), shown as a support post 114. The support post 114 extends radially outward from a central axis of the flow device 104 such that the support post 114 is clear of the fluid stream 14 during operation (i.e., the support post 114 does not disrupt the fluid stream 14 at any position along the fluid stream 14).

In the embodiments of FIGS. 2–3, a second end 117 of the support member 106 is coupled to the flow distribution member 108 (e.g., via the water vapor dispensing system 102). In other embodiments, the second end 117 may be directly coupled to the flow distribution member 108, or to another intermediate support structure that is coupled to the flow distribution member 108. In the embodiment of FIGS. 2–3, the second end 117 is disposed adjacent to an outer perimeter of the flow distribution member 108.

In some embodiments, the flow distribution member 108 defines a cavity 120 (e.g., hollow portion, recessed area) configured to receive a retain a volume of water during operation of the showerhead.

The flow distribution member 108 includes a base (which may also be referred to as a flow distribution plate or panel), shown as wall 116, defining a substantially planar surface oriented substantially normal to a central axis of the flow device 104 and the fluid stream 14. The planar surface faces an outlet of the flow device 104. In some embodiments, the flow distribution member 108 also includes a ledge, shown as a lip 118, disposed along a perimeter of the wall 116. In some embodiments, the flow distribution member 108 is stamped or otherwise formed from a single piece of material (e.g., brass, stainless steel, or another corrosion resistant material such as a plastic material).

Together, the wall 116 and the lip 118 define a cavity 120 forming an upwardly facing cup-shape that faces toward the flow device 104. In some embodiments, the lip 118 extends substantially perpendicular to the wall 116. In other embodiments, the lip 118 extends away from the wall 116 at a non-perpendicular (e.g., oblique) angle. In yet other embodiments, the wall 116 may extend perpendicularly, the flow distribution member 108 is formed without a lip 118 (e.g., as a flat plate), or includes a lip that extends at least partially below the flow distribution member 108 so that the wall 116 is disposed at least partially between the lip and the flow device 104.

The flow distribution member 108 may be configured in a variety of different geometries depending on flow requirements (e.g., water flow rate and flow intensity) and user preferences. In the embodiment of FIGS. 1–3, the flow distribution member 108 is configured as a circular plate having a diameter of about 12 in (30.5 cm). The flow distribution member 108 is configured to provide a distributed fluid flow at flow rates within a range of about 1.75 gpm (6.6 L/min water) to 3.5 gpm (13.2 L/min). Alternatively, the flow distribution member 108 may be rectangular or have both straight and curved edges. Various other geometries for the flow distribution member 108 are possible.

The flow distribution member 108 (e.g., the wall 116) defines a plurality of openings (e.g., perforations, holes, nozzles, etc.). During operation, fluid from the flow device 104 is pulled through the openings by the force of gravity. In some embodiments, the fluid separates from a lower surface of the wall 116 in droplets simulating a rainfall pattern. As described above, the wetted surfaces of the flow distribution member 108, on both sides of the flow distribution member 108, are completely or at least partially open to the atmosphere, thereby allowing water to drain quickly and completely after use. Any water remaining on the flow distribution member 108 after the flow of water has been terminated may evaporate freely to the surroundings.

The size, number, shape, and arrangement of openings in the flow distribution member 108 may vary depending on the flow requirements for the showerhead 100 and user preferences. In the embodiment of FIGS. 1–3, a total of about 91 circular holes are disposed in the flow distribution member 108. In other embodiments, the flow distribution member 108 may include more or fewer openings. In some embodiments, the holes are distributed in concentric rows on the wall 116, each row including a plurality of holes in a substantially circular pattern (e.g., a bullseye configuration, etc.).

A diameter of the holes in the flow distribution member 108 may also vary depending on the required flow rate of fluid (and multiple different hole diameters may be used in a single showerhead to provide droplets of different sizes to the user). In some embodiments, the diameter of each hole may be any size within a range substantially between about 0.12 in and 0.14 in. A height of the lip 118 (e.g., a distance between an upper edge of the lip 118 and the upper surface of the wall 116) for the flow distribution member 108 may also vary. In some embodiments, the height of the lip 118, normal to the upper surface of the wall 116 is sufficient to allow a quantity of water to pool within the cavity across substantially all of the openings of the flow distribution member 108.

Referring again to FIGS. 2–3, the support member 106 is integrally formed with a portion of the flow device 104 (e.g., an outer body of the flow device 104). The support member 106 includes the support post 114 and a retaining ring 122 that is disposed at a lower end of the support post 114. The retaining ring 122 couples the support post 114 to the water vapor dispensing system 102 and the flow distribution member 108. In other embodiments, the retaining ring 122 may be secured to the support post 114 via a fastener, or may be integrally formed with the support post 114 as a single unitary structure.

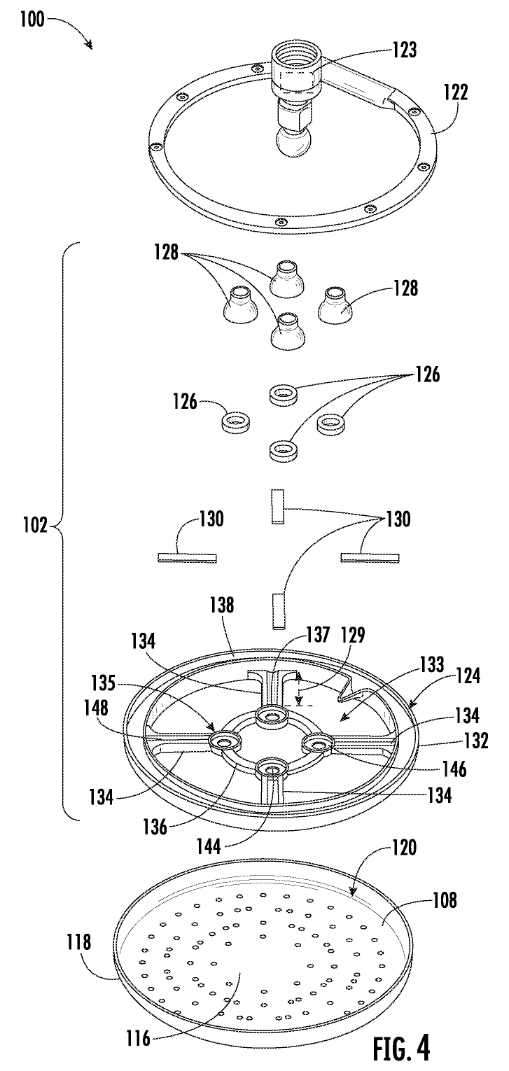

Referring to FIG. 4, the water vapor dispensing system 102 is coupled to the showerhead 100 between the retaining ring 122 and the flow distribution member 108. In some embodiments, the water vapor dispensing system 102 is disposed in a recessed area defined by the retaining ring 122 and the wall 116 (e.g., within the cavity 120). In some embodiments, and as shown, the water vapor dispensing system 102 is detachably coupled (e.g., removably coupled) to the showerhead 100 so that the water vapor dispensing system 102 can be removed and replaced in the event of damage, or retrofit onto an existing showerhead (e.g., in place of another support structure between the retaining ring 122 and the flow distribution member 108), as will be further described.

The water vapor dispensing system 102 includes a support frame 124, a mist element 126 (see also FIG. 4), and a control system 131 (see also FIG. 3). In some embodiments, the water vapor dispensing system 102 also includes a mist element cover 128 and/or a light element 130. The support frame 124 is configured to couple the mist element 126 to the showerhead and is configured to provide water delivered from the showerhead to the mist element 130. In some embodiments, the support frame 124 is configured to support the mist element 126, the mist element cover 128, and the light element 130 in position relative to the flow distribution member 108. In the embodiment of FIG. 4, the support frame 124 is configured to support the mist element 126 at least partially within the cavity 120 of the flow distribution member 108 during operation.

The support frame 124 (which may also be referred to as a support element, support member, and/or frame) includes a support ring 132 and a plurality of extensions pieces 134 (which may also be referred to as extensions) extending radially inward from the support ring 132. In the embodiment of FIG. 4, the support frame 124 includes four extension pieces 134. In other embodiments, the support frame 124 may include additional or fewer extension pieces 134.

The support ring 132 is configured to couple the support frame 124 to the flow distribution member 108 and the retaining ring 122. In the embodiment of FIG. 4, the support ring 132 is sized to nestably engage (e.g., nest within) the flow distribution member 108, within the cavity 120 defined by the wall 116 and the lip 118. An outer diameter of the support ring 132 is slightly less than an inner diameter of the lip 118. In some embodiments, the support ring 132 defines a recessed area that is sized to nestably engage the retaining ring 122. In some embodiments, the support ring 132 is sized to engage the lip 118 in a clearance or transition fit arrangement in which the support ring 132 slides along, and does not interfere with, the lip 118 during assembly. In other embodiments, the support ring 132 is sized to engage an inner surface of the lip 118 in a friction fit arrangement so that a force is required to press the support ring 132 into the flow distribution member 108. Beneficially, such an arrangement can help align and/or retain the support ring 132 within the cavity 120 during assembly. In other embodiments, the support ring 132 is sized to nestably engage the recessed area formed between the retaining ring 122 and the wall 116.

The extension pieces 134 extend at least partially across a central opening 133 that is defined by the support ring 132. In the embodiment of FIG. 4, the extension pieces 134 each define a mount 135 at an outer end thereof that is configured to receive and support a mist element 126 therein.

In some embodiments, and as shown, a length 129 of the extension pieces 134, between the support ring 132 and mounts 135, is equal to approximately one fourth of the total diameter of the support ring, one third of the total diameter of the support ring, two fifths of the total diameter of the support ring 132, or another length, such as up to, and including, one half of the total diameter of the support ring 132. Such an arrangement can help to ensure that the mist elements 126 are supported within a region in which water has pooled inside of the cavity 120 of the flow distribution member 108 during operation, and can spread the aerosolized water vapor more uniformly across the open region between the flow device 104 and the flow distribution member 108. In other embodiments, the position of the mounts 135 along the extensions pieces 134 may be different (e.g., the extension pieces 134 may extend fully across the central opening 133, forming an “X” shape, and the mounts 135 may be disposed at approximately equal intervals along the extension pieces 134, etc.). In yet other embodiments, the flow distribution member 108 may have a non-circular shape and the extension pieces 134 and/or the support ring 132 may have another arrangement to space the mist elements 126 across an upper surface of the flow distribution member 108.

In some embodiments, and as shown, the support frame 124 also includes an inner ring 136 coupled to an inner radial end of each of the extension pieces 134, which can increase the strength of the extension pieces 134. The inner ring 136 may be concentric with the support ring 132 and have the same central axis as the support ring 132. In other embodiments, the extension pieces 134 may be connected to one another at another location along their length.

In some embodiments, and as shown, a height of the support frame 124, including the support ring 132 and the extension pieces 134 is less than a height of the lip 118. Such an arrangement can, beneficially, help to ensure that the mist elements 126 remain in contact with, or at least partially submersed in, water pooling within the cavity 120 during operation. Such an arrangement can also improve the overall aesthetic appearance of the showerhead 100 by concealing at least portions of the water vapor dispensing system 102.

In some embodiments, the support ring 132 defines a recessed area, shown as channel 138, that extends along the perimeter of the support ring 132. In the embodiment of FIG. 4, the channel 138 has a rectangular profile along a cross-section taken normal to a radial reference plane extending through the support ring 132. In other embodiments, the cross-sectional profile of the channel 138 may be different. For example, the channel 138 may have a “U” shaped profile, a “V” shaped profile, or be formed in another shape.

As shown in FIG. 4, the channel 138 is sized to receive at least a portion of the retaining ring 122 therein. In some embodiments, the retaining ring 122 is sized to nestably engage the channel 138, such that the retaining ring 122 nests within the channel 138. In some embodiments, a height of the channel 138 is approximately equal to, or greater than, a height of the retaining ring 122. Such an arrangement can reduce the profile of the showerhead 100 and help to conceal components of the water vapor dispensing system 102 behind the flow distribution member 108 (e.g., behind the lip 118), such that the water vapor dispensing system 102 is at least partially concealed from the user when the showerhead 100 is viewed from the side (e.g., along a radial direction).

The support ring 132 is coupled to the retaining ring 122 and the flow distribution member 108. In some embodiments, the retaining ring 122 defines openings spaced at intervals along an outer perimeter thereof to enable fastening of the retaining ring 122 to the support ring 132 (e.g., via screws, bolts, or another type of mechanical fastener). In some embodiments, the same fasteners may be used to secure the support ring 132 to the flow distribution member (e.g., to the wall 116). Such an arrangement can enable removal and replacement of the water vapor dispensing system 102 without damaging the flow distribution member 108 or the flow device 104. In other embodiments, the support ring 132 may be press fit into the flow distribution member 108, adhered with an adhesive product, welded, or otherwise affixed to the flow distribution member 108.

The mounts 135 are configured to support respective ones of the mist elements 126 therein, and to at least partially submerge the mist element(s) 126 in water that pools within the cavity 120 during operation. In some embodiments, the mounts 135 are defined as recessed areas 137 (e.g., depressions, etc.) in the extension pieces 134. In some embodiments, the recessed areas 137 have a cross-sectional profile normal to a central axis thereof that corresponds with (e.g., matches) a cross-sectional profile of the mist elements 126 and/or the element covers 128. In some embodiments, the recessed areas 137 have a circular profile when viewed normal to a central axis of the recessed area 137. In other embodiments, the shape of the recessed areas 137 may be different.

In some embodiments, the support frame 124 defines an opening (e.g., an aperture) extending therethrough at the mist element 126 that is configured to allow water to pass therethrough and onto the mist element 126. In the embodiment of FIG. 4, each one of the extension pieces 134 defines a recessed area 137 at an inner radial end of the extension pieces 134. The extension pieces 134 also include a through-hole opening 144 (e.g., an aperture) that extends through a central portion of the recessed area 137 at each of the mounts 135. The recessed area 137 and the through-hole opening 144 together define a ledge, shown as a step 146, that is configured to support the mist element 126 within the recessed area. A diameter of the opening 144 is less than a diameter of the recessed areas 137. The through-hole openings 144 extend through the extension pieces 134 and fluidly couple the mounts 135 to the cavity 120.

The mist element 126 (which may also be referred to as a nebulizer) is configured to generate an aerosolized mist (e.g., fog, etc.) of water (e.g., a water vapor, shown as a mist 18 in FIG. 1) from the water received by the flow distribution member 108. In some embodiments, the mist element 126 is configured to generate the mist 18 from water retained within the flow distribution member 108 (e.g., from water that has pooled in the cavity 120 during operation). In some embodiments, the mist element 126 includes an ultrasonic device, such as a piezoelectric device (e.g., an ultrasonic sensor, a piezoelectric sensor, etc.) that is configured to generate the mist 18 by applying a high-frequency sounds wave to vibrate the water and thereby form the mist 18. In the embodiment of FIG. 4, the piezoelectric device includes a piezoelectric disk defining a central opening extending therethrough. In other embodiments, the mist element 126 may include another type of device that can generate a fog from water received by the cavity 120.

In some embodiments, the mist element 126 is also configured to enhance diffusion of aromatic compounds introduced into the water supply, and/or introduced directly to the mist element 126. For example, as shown in FIG. 4, the showerhead 100 may include a shower infusion device 123 (e.g., an inline dispensing device, an inline filter, a fragrance filter, a fragrance dispenser, a scented pod, an essential oil diffuser, etc.) that is configured to deliver an aromatic compound (e.g., a fragrance, and essential oil, etc.) to the water before delivering the water to the flow distribution member 108. The shower infusion device 123 may be disposed within the flow device 104 or at another location (e.g., upstream from the showerhead 100 such as between the shower arm and the showerhead 100; between a hand shower hose and a hand shower; within the flow distribution member 108; between the flow device 104 and the flow distribution member 108; or any other arrangement in which the mist element 126 may be exposed to the aromatic compound(s)/fragrance(s)). The mist element 126 is configured to atomize the aromatic compound(s), increasing the surface area of the water particles and/or aromatics, which can intensify the dispersion of volatile aromatic molecules and enhance a user’s overall sensory experience.

As shown in FIG. 4, the mist element is one of a plurality of mist elements 126 that are configured to be disposed in respective ones of the mounts 135, such that the central opening of the mist elements 126 are aligned (e.g., axially) with respective ones of the through-hole openings 144 of the mounts 135. Such an arrangement can, beneficially, allow water from the cavity 120 to enter the mounts 135 and at least partially submerge the piezoelectric device. It should be understood that the shape, number, and/or arrangement of the mist elements 126 may be different in various embodiments.

The mist element cover 128 (which may also be referred to as a ultrasonic and/or piezoelectric sensor cover and/or a mist deflector) is configured to protect a respective one of the mist element 126 and/or to direct the mist 18 (see also FIG. 1) produced by the respective one of the mist elements 126 away from the flow distribution member 108 and into the region 110 above the flow distribution member 108, between the flow distribution member 108 and the flow device 104 (e.g., such that the mist 18 is directed out of the showerhead 100 from an opposite side of the flow distribution member 108 as the spray of water). In some embodiments, and as shown, the showerhead 100 includes a plurality of mist element covers 128 (e.g., nozzles), one for each of the mist elements 126. The mist element covers 128 are coupled to the support ring 132 at the mounts 135 and extend axially away from the mounts 135 and toward the flow device 104. In the embodiment of FIG. 4, a central axis of each of the mist element covers 128 is arranged substantially parallel to a central axis of the flow device 104. In other embodiments, the orientation of the mist element covers 128 may be different (e.g., the mist element covers 128 may extend at a non-perpendicular angle relative to the wall 116 of the flow distribution member 108, etc.).

In the embodiment of FIG. 4, the mist element covers 128 are hollow caps that extend over the mist elements 126, such that the mist elements 126 are “sandwiched” or otherwise disposed between the caps and the mounts 135. An inner diameter of the caps decreases along an axial direction, moving away from the mist elements 126. Such an arrangement can direct and/or accelerate the mist away from the flow distribution member 108 and out from the showerhead 100 through the region 110.

The light element 130 is configured to illuminate the mist 18 (see also FIG. 1) in at least a portion of the region 110 between the flow distribution member 108 and the flow device 104. In some embodiments, and as shown, the water vapor dispensing system 102 includes a plurality of light elements 130 that are coupled to the support ring 132. In the embodiment of FIG. 4, the light elements 130 are elongated light emitting diode (LED) strips that are coupled to respective ones of the extension pieces 134.

In some embodiments, the extension pieces 134 are configured to support the LED strips and to direct light from the LED strips away from the flow distribution member 108 (e.g., toward the flow device 104, toward a ceiling of the shower enclosure, etc.). In some embodiments, and as shown, the extension pieces 134 define a second recessed area 148 in an upper surface thereof and between opposing ends of the extension pieces 134. The LED strips are sized to nestably engage respective ones of the second recessed areas 148, which can help to conceal the LED strips from a user’s view during showering.

The control system 131 is configured to power and control operation of the water vapor dispensing system 102 (e.g., the mist element 126). Referring to FIG. 3, the control system 131 may be embodied as a control module including one or more processing circuits and memory coupled to the support frame 124 and/or the support ring 132 (e.g., within a portion of the support frame 124, within a portion of the support ring 132), or to another portion of the showerhead 100. In other embodiments, the control system 131, or portions thereof, may be located remote from the showerhead.

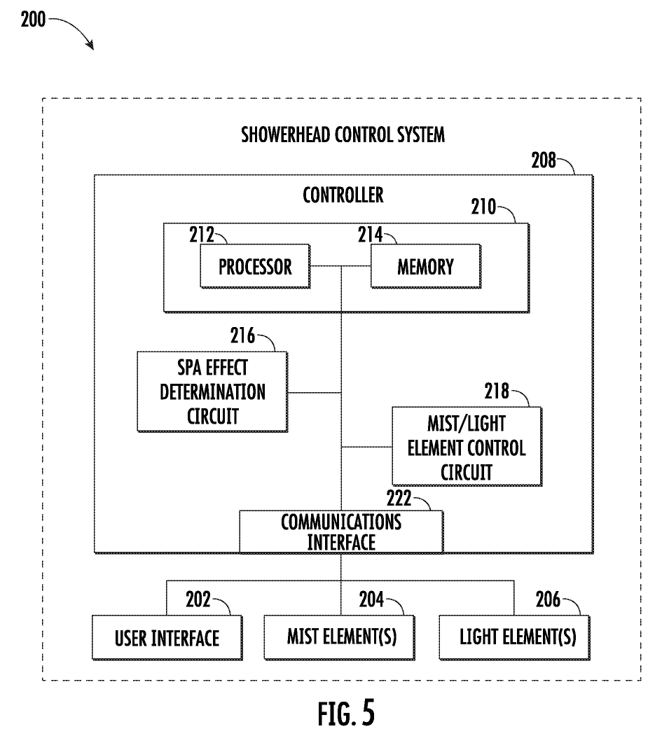

Referring to FIGS. 4 and 5, in some embodiments, the water vapor dispensing system 102 includes the mist element 126, the light element 130, a user interface 202 (FIG. 5), and a controller 208 (FIG. 5). The controller 208 may be operably coupled to the user interface 202, the mist element 126, and the light element 130, and may be configured to: receive a fog characteristic from the user interface; and coordinate operation of the mist element and the light element based on the fog characteristic, as will be further described.

Referring to FIG. 5 a block diagram of the control system 200 is shown that can be used with the water vapor dispensing system 102 of FIGS. 1–4, according to an embodiment. The control system 200 includes a user interface 202, a mist element 204, a light element 206, and a controller 208. In other embodiments, the control system 200 may also include one or more actuators to control operation of the flow device (e.g., to coordinate operation of the flow device 104 with the water vapor dispenser).

The user interface 202 is configured as a human-machine interface to enable user interaction with the water vapor dispenser (e.g., the mist element 204 and/or the light element 206). The user interface 202 may include an input/output interface (e.g., an I/O interface) that is configured to receive user inputs. For example, the user interface 202 may include one or more actuators and/or a touch screen display. The user interface 202 may be a remote device (e.g., a phone, a tablet, or another mobile computing device) that is communicably coupled to the controller 208. In some embodiments, the user interface 202 is configured to receive user selections regarding a desired fog characteristic associated with operation of the mist element 204 and/or the light element 206, as will be further described.

The mist element 204 and the light element 206 may be the same as the mist element 126 and light element 130, respectively, described with reference to FIGS. 1–4. The mist element 204 and the light element 206 may be one of a plurality of mist elements 204 and light elements 206, respectively, in various embodiments.

The controller 208 is operably (e.g., communicably) coupled to the user interface 202, the mist element(s) 204, and the light element(s) 206, and is configured to receive and interpret data from and/or control operation of the user interface 202, the mist element(s) 204, and the light element(s) 206. In some embodiments, the controller 208 is configured to coordinate operation of the mist element 126 with the light element 130. In the embodiment of FIG. 5, the controller 208 includes a processing circuit 210 including a processor 212 and memory 214; a spa effect determination circuit 216 (e.g., a spa effect control module, etc.); a mist/light element control circuit 218 (e.g., a mist/light element control module, etc.); and a communications interface 222. In other embodiments, the controller 208 may include different arrangements of circuits.

The processor 212, which may include one or more processors, microprocessors, etc., is communicably coupled to the memory 214, the spa effect determination circuit 216, the mist/light element control circuit 218, and the communications interface 222, and is configured to coordinate and control operations of each of the circuits and the communications interface 222. The memory 214 is configured to store data and or computer code for facilitating the various processes described herein. The memory 214 may include a tangible non-transient volatile memory that is configured to store instructions thereon which, when executed, causes the processor 212 to perform any of the operations described herein.

The spa effect determination circuit 216 and the mist/light element control circuit 218 may be embodied as software modules stored in memory 214. In such arrangements, the spa effect determination circuit 216 and the mist/light element control circuit 218 may form part of an edge computing device that is configured to perform operations without requiring access to the Internet. In other embodiments, at least one of the spa effect determination circuit 216 and the mist/light element control circuit 218 may be embodied as one or more separate circuits or may form part of a cloud infrastructure component that is communicably coupled to the controller 208 via the Internet.

The spa effect determination circuit 216 is configured to receive and/or determine a fog characteristic of the illuminated mist generated by the water vapor dispenser. The fog characteristic may include a desired operating condition of the water vapor dispenser, such as an intensity of the mist (e.g., a rate of mist generation, a number of active mist elements 204, etc.), a duration of mist generation, a color of the light emitted by the light element 206, and/or an intensity of the light emitted by the light element 206. In other embodiments, the fog characteristic may include a sequence of operating conditions of the mist element 204 and/or the light element 206 over time.

In some embodiments, the spa effect determination circuit 216 is configured to generate a graphical user interface (GUI) including a list of user-selectable fog characteristics, and to transmit the GUI to the user interface 202.

The spa effect determination circuit 216 may be configured to determine (e.g., from a lookup table, etc.) an operating condition of the mist element 204 and/or the light element 206 that corresponds with the user selections received from the user interface 202. In other embodiments, the mist/light element control circuit 218 is configured to determine the operating condition of the mist element 204 and/or the light element 206 based on fog characteristics received from the spa effect determination circuit.

The mist/light element control circuit 218 is configured to control the mist element(s) 204 and/or the light element(s) 206 based on the operating conditions to produce the requested fog characteristic(s). In some embodiments, the mist/light element control circuit 218 is configured to transmit a control signal to the mist element(s) 204 and/or the light element(s) 206 based on the operating condition(s). The control signal may cause the mist element(s) 204 and/or the light element(s) 206 to activate, to change a duty cycle and/or frequency of operation, or to activate/deactivate subsets of mist element(s) 204 and/or light element(s) 206 based on a sequence input by the user. Such an arrangement can allow for various user-defined operating modes and can enable personalization of the spa-like effects generated by the water vapor dispenser.

The communications interface 222 is configured to control data exchange between various components of the water vapor dispenser and the controller 208. The communications interface 222 may include a wired and or wireless interface (e.g., Bluetooth®, a local area network (LAN), near field communications, etc.) for conducting communications.

In some embodiments, the control system 200 (e.g., the mist element 204, the light element 206, the controller 208, etc.) is powered by a battery pack. In other embodiments, the control system 200 is powered by AC power from the building in which the showerhead is located. In yet other embodiments, the control system 200 may be powered by a hydrogenator that is integrated into the showerhead.

Another embodiment relates to a method of manufacturing a showerhead including a water vapor dispensing system. In some embodiments, the method includes forming a support frame that is configured to couple a mist element to the showerhead, and/or to support the mist element at least partially within a water receiving cavity of the showerhead. In some embodiments, the method includes coupling a mist element and/or a light element to a support frame, such as by inserting the mist element and/or the light element in recessed areas defined by the support frame. For example, the method may include engaging the mist element with a ledge of the support frame defined by a recessed area and an aperture, where the aperture is configured to allow water to pass therethrough and onto the mist element. In some embodiments, the method includes placing a mist element cover over the mist element.

The method further includes coupling the support frame to the showerhead. For example, the method may include inserting the support frame into a fluid receiving cavity of the showerhead. The method may also include orienting the mist elements to generate mist in a region that is open to the atmosphere surrounding the showerhead.

As utilized herein with respect to numerical ranges, the terms “approximately,” “about,” “substantially,” and similar terms generally mean +/- 10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the showerhead assembly and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A showerhead comprising:
a flow device;
a flow distribution member coupled to the flow device and spaced apart from the flow device by a region that is open to an atmosphere surrounding the showerhead; and
a water vapor dispensing system coupled to the flow distribution member, the water vapor dispensing system including a mist element that is configured to generate a mist within the region from water received by the flow distribution member.

2. The showerhead of claim 1, wherein the flow distribution member defines a cavity configured to receive and retain a volume of water during operation, further comprising a support member coupling the flow device to the flow distribution member, the mist element supported in fluid receiving arrangement with the cavity by the support member.

3. The showerhead of claim 1, wherein the flow distribution member comprises:
a distribution plate; and
a lip extending along an outer perimeter of the distribution plate, the distribution plate and the lip together defining a cavity facing toward the flow device, the water vapor dispensing system further comprising a support frame disposed within the cavity and extending across at least a portion of the cavity, the mist element coupled to the support frame.

4. The showerhead of claim 1, wherein the water vapor dispensing system further comprises a mist element cover coupled to the mist element and configured to direct mist received from the mist element away from the flow distribution member and at least partially toward the flow device.

5. The showerhead of claim 1, wherein the water vapor dispensing system further comprises a light element coupled to the flow distribution member, the light element configured to illuminate at least a portion of the region.

6. The showerhead of claim 5, wherein the water vapor dispensing system further comprises a controller configured to coordinate operation of the mist element with the light element.

7. The showerhead of claim 1, wherein the flow distribution member defines a cavity configured to receive and retain a volume of water from the flow device during operation, and wherein the mist element is disposed within the cavity.

8. The showerhead of claim 1, wherein the mist element includes a piezoelectric device configured to generate an aerosolized mist of water.

9. The showerhead of claim 1, wherein the water vapor dispensing system includes a support frame coupled to the flow distribution member and supporting the mist element, the support frame defining an opening at the mist element configured to allow water to pass therethrough and onto the mist element.

10. A water vapor dispensing system for a showerhead, the water vapor dispensing system comprising:
a mist element;
a support frame configured to couple the mist element to the showerhead and configured to provide water delivered from the showerhead to the mist element; and
a control system configured to control operation of the mist element.

11. The water vapor dispensing system of claim 10, wherein the support frame includes a mount defining a recessed area, the support frame defining an aperture that extends through a central portion of the recessed area, the recessed area and the aperture together defining a ledge, the mist element disposed on the ledge.

12. The water vapor dispensing system of claim 10, wherein the support frame includes a support ring and an extension extending radially inwardly from the support ring, the extension defining a mount, the mist element coupled to the mount.

13. The water vapor dispensing system of claim 10, wherein the mist element is one of a plurality of mist elements coupled to the support frame.

14. The water vapor dispensing system of claim 10, wherein the mist element is a piezoelectric device configured to generate an aerosolized mist of water, and wherein the support frame is configured to support the mist element within a cavity of the showerhead.

15. The water vapor dispensing system of claim 10, further comprising a cover coupled to the support frame and extending over the mist element.

16. The water vapor dispensing system of claim 15, wherein an inner diameter of the cover decreases along an axial direction moving away from the mist element.

17. The water vapor dispensing system of claim 10, further comprising a light element coupled to the support frame, wherein the control system is configured to coordinate operation of the mist element with the light element.

18. A water vapor dispensing system comprising:
a mist element configured to be coupled to a showerhead and to generate an aerosolized mist from water delivered by the showerhead;
a light element;
a user interface; and
a controller operably coupled to the user interface, the mist element, and the light element, the controller configured to:
receive a fog characteristic from the user interface; and
coordinate operation of the mist element and the light element based on the fog characteristic.

19. The water vapor dispensing system of claim 18, further comprising a support frame configured to couple the mist element and the light element to the showerhead.

20. The water vapor dispensing system of claim 18, wherein the controller is further configured to control at least one of a duty cycle or a frequency of operation of the mist element or the light element based on the fog characteristic.
